(19) United States
(12) Patent Application Publication
(10) Pub. No.: US 2019/0367851 A1
(43) Pub. Date: Dec. 5, 2019

(54) NONWOVEN MATERIAL FOR CLEANING AND SANITIZING SURFACES

(71) Applicant: Georgia-Pacific Nonwovens LLC, Atlanta, GA (US)

(72) Inventors: Jacek K Dutkiewicz, Cordova, TN (US); Jessica S Flinn, Hernando, MS (US)

(73) Assignee: Georgia-Pacific Nonwovens LLC, Atlanta, GA (US)

(21) Appl. No.: 16/477,420

(22) PCT Filed: Jan. 12, 2018
(86) PCT No.: PCT/US18/13546

§ 371 Date: Jul. 11, 2019

Related U.S. Application Data
(60) Provisional application No. 62/445,696, filed on Jan. 12, 2017.

(51) Int. Cl. C11D 17/04; C11D 3/48; C11D 3/22; C11D 3/30; A01N 25/10; A01N 33/12

(52) U.S. Cl. CPC C11D 17/049; C11D 3/48; A01N 33/12; C11D 3/30; A01N 25/10; C11D 3/222

(57) ABSTRACT

Nonwoven materials having at least one layer are provided, as well as their use in cleaning articles. More particularly, the nonwoven materials can comprise modified cellulose fibers. The modified cellulose fibers can repel a sanitizing agent, such as a quaternary ammonium compound, from the surface of the nonwoven material. The nonwoven material including modified cellulose fibers can also have improved antimicrobial properties. The modified cellulose fibers can contain aluminum that is fixed to the fibers such that it does not leach when the nonwoven materials are stored in a liquid environment.

### 1.FIELD OF THE INVENTION

The presently disclosed subject matter relates to new nonwoven materials and their use in cleaning articles. In certain aspects, the presently disclosed subject matter relates to nonwoven materials including modified cellulose fibers, which can be used in combination with a sanitizing agent and which have antimicrobial properties.

### 2. BACKGROUND OF THE INVENTION

Nonwoven materials are important in a wide range of cleaning articles, including cleaning wipes, cloths, and sheets. Nonwoven materials made from synthetic and cellulose fibers are suitable for cleaning applications because they can be a disposable and cost-effective single-use alternative to existing fabric cloths and sponges. In some applications, the nonwoven materials are treated with a cleaning solution to create a nonwoven material infused with a cleaning agent to aid in dirt, stain, or odor removal. The cleaning agent may also have biocidal properties to sanitize or disinfect surfaces. Wet wipes often attract and collect particles better than dry alternatives, although dry wipes may have electrostatic properties to assist in attracting and collecting such particles.

Cleaning wipes are used in a broad range of applications, including household, personal care, and industrial applications. It is desirable to have a durable wipe that does not disintegrate upon use. For cleaning purposes, ideal materials are flexible in order to conform to the surface being cleaned. It is also beneficial to create thinner wipes that require less material and which are simple to manufacture.

As mentioned above, nonwoven materials can be treated with a cleaning solution to form a wet wipe. For example, it can be desirable to treat a nonwoven material with a liquid including a sanitizing agent. Cationic compounds, such as quaternary ammonium compounds, are commonly used as a sanitizing agent. However, such cationic compounds can be attracted to and absorbed into nonwoven materials. As the liquid is released from the nonwoven material, for example, during cleaning, a portion of the cationic compound can remain in the nonwoven material, thus reducing the sanitizing capacity of a cleaning wipe. Additionally, after storage in a wet environment, such as with a cleaning solution, nonwoven materials can exhibit mold growth.

Thus, there remains a need for a durable nonwoven material that can be used in cleaning applications and that can effectively sanitize and scrub surfaces, and which can remain resistant against mold growth when stored in liquid. The disclosed subject matter addresses these needs.

### 3. SUMMARY

The presently disclosed subject matter provides for a nonwoven material comprising at least one layer, at least two layers, at least three layers, at least four layers, or at least five layers, where each of the layers has a specific layered construction. In certain embodiments, the nonwoven material includes at least one layer comprising modified cellulose fibers. The modified cellulose fibers can repel a sanitizing agent from the surface of the nonwoven material. Additionally, the modified cellulose fibers can impart antimicrobial properties to the nonwoven material.

In certain aspects, the disclosed subject matter provides for a nonwoven material comprising from about 10 wt-% to about 90 wt-% of modified cellulose fibers, from about 10 wt-% to about 90 wt-% of synthetic fibers, and a solution comprising a sanitizing agent.

In certain embodiments, the modified cellulose fibers comprise aluminum. In certain embodiments, less than about 200 ppm, less than about 100 ppm, or less than about 50 ppm, of the aluminum leaches from the nonwoven material to the solution. The modified cellulose fibers can further comprise a weak acid. In certain embodiments, the synthetic fibers can be bicomponent fibers.

In certain other aspects, the disclosed subject matter provides for a nonwoven material comprising modified cellulose fibers that are treated with a polyvalent metal salt and a solution comprising a sanitizing agent. For example, and not limitation, the polyvalent metal salt can be an aluminum salt. In certain embodiments, less than about 200 ppm, less than about 100 ppm, or less than about 50 ppm, of the aluminum leaches from the nonwoven material to the solution. The modified cellulose fibers can further comprise a weak acid.

The presently disclosed nonwoven materials can have a basis weight of from about 30 gsm to about 200 gsm. The nonwoven materials can have a caliper of from about 0.3 mm to about 2.0 mm. In certain embodiments, the nonwoven materials comprise two or more layers.

In certain embodiments, the nonwoven materials can have a CDW tensile strength of greater than about 200 g/inch, or greater than about 400 g/inch. The nonwoven materials can have a MDD tensile strength of greater than about 300 g/inch, or greater than about 800 g/inch.

In certain embodiments, the sanitizing agent can be a quaternary ammonium compound. For example, the quaternary compound can be dioctyldecyl dimethyl ammonium chloride, octyl decyl dimethyl ammonium chloride, alkyl dimethyl benzyl ammonium chloride, or a combination thereof. The nonwoven materials can have a quat depletion of at least about 40% as compared to the initial amount of the quaternary ammonium compound in the solution before the solution is applied to the nonwoven material. In certain embodiments, the nonwoven materials can further include an anti-microbial agent. The nonwoven materials can be mold resistant when stored in an aqueous environment for at least about 35 days, at least about 75 days, or at least about 90 days.

The foregoing has outlined broadly the features and technical advantages of the present application in order that the detailed description that follows may be better understood. Additional features and advantages of the application will be described hereinafter which form the subject of the claims of the application. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of the application, both as to its organization and method of operation, together with further objects and advantages will be better understood from the following description.

### 4. BRIEF DESCRIPTION OF THE DRAWINGS

FIG. 1 provides photographs of four sample nonwovens (Samples 1A-1D) of Example 1, after storage in an aqueous environment for 18 days. Mold can be seen in Samples 1A and 1C.

FIG. 2 provides a photograph of Sample 1D of Example 1, after storage in an aqueous environment for 53 days. Mold can be observed within the circled portions of FIG. 2.

FIGS. 3A-3B provide photographs of Samples 4B and 4D of Example 4, after storage for 36 days, where FIG. 3A depicts Sample 4B and FIG. 3B depicts Sample 4D.

### 5. DETAILED DESCRIPTION

As noted above, to date, there remains a need in the art for improved nonwoven materials for sanitizing and scrubbing surfaces. The presently disclosed subject matter provides a nonwoven material having at least one layer, and including modified cellulose fibers for repelling a sanitizing agent from the surface of the nonwoven material. The modified cellulose fibers can include aluminum that is fixed to the fibers such that it does not leach when the nonwoven materials are stored in a liquid environment. The presently disclosed subject matter also provides methods for making such materials. These and other aspects of the disclosed subject matter are discussed more in the detailed description and examples.

### Definitions

The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used herein, a “nonwoven” refers to a class of material, including but not limited to textiles or plastics. Nonwovens are sheet or web structures made of fiber, filaments, molten plastic, or plastic films bonded together mechanically, thermally, or chemically. A nonwoven is a fabric made directly from a web of fiber, without the yarn preparation necessary for weaving or knitting. In a nonwoven, the assembly of fibers is held together by one or more of the following: (1) by mechanical interlocking in a random web or mat; (2) by fusing of the fibers, as in the case of thermoplastic fibers; or (3) by bonding with a cementing medium such as a natural or synthetic resin.

As used herein, the term “weight percent” is meant to refer to either (i) the quantity by weight of a constituent/component in the material as a percentage of the total dry weight of a layer of the material; or (ii) to the quantity by weight of a constituent/component in the material as a percentage of the total dry weight of the final nonwoven material or product.

The term “basis weight” as used herein refers to the quantity by weight of a compound over a given area. Examples of the units of measure include grams per square meter as identified by the acronym “gsm”.

As used herein, the phrase “chemically modified,” when used in reference to a fiber, means that the fiber has been treated with a polyvalent metal-containing compound to produce a fiber with a polyvalent metal-containing compound bound to it. It is not necessary that the compound chemically bond with the fibers, although it is preferred that the compound remain associated in close proximity with the fibers, by coating, adhering, precipitation, or any other mechanism such that it is not dislodged from the fibers during normal handling of the fibers. In particular, the compound can remain associated with the fibers even when wetted or washed with a liquid. For convenience, the association between the fiber and the compound may be referred to as the bond, and the compound may be said to be bound to the fiber.

As used herein, the term “sanitizing agent” refers to a compound that has biocidal properties. For example, a sanitizing agent can have antimicrobial, antibacterial, antiviral, antifungal, antiprotozoal and/or antiparasitic properties. Sanitizing agents can be capable of reducing or eliminating the presence of microbes, including bacteria, viruses, and fungi.

As used herein, the term “quat depletion” refers to the amount (e.g., weight percent or concentration) of a quaternary ammonium compound in a solution that has been released from a nonwoven material. For example, the solution can be released wringing, squeezing, pressing, or otherwise applying pressure to the nonwoven material. Quat depletion can be measured by titration of the released solution. Quat depletion can be compared to the initial amount of the quaternary ammonium compound in the solution prior to the solution being applied to the nonwoven material, to determine the percentage of the quaternary ammonium compound that was released by the nonwoven material.

As used herein, the term “mold resistant” when used in reference to a nonwoven material means that no observable mold appears on the nonwoven material within a certain time period. “No observable mold” means that no mold appears that is visible to the naked eye. The time period can be at least about 5 days, at least about 7 days, at least about 14 days, at least about 18 days, at least about 21 days, at least about 29 days, at least about 33 days, at least about 35 days, at least about 37 days, at least about 50 days, at least about 60 days, at least about 75 days, at least about 77 days, at least about 85 days, at least about 91 days, or at least about 100 days. For purpose of example, and not limitation, suitable procedures for evaluating mold resistances are described in the “USP <51> Preservative Challenge Test for Personal Care Products,” available at http ://microchemlab.com/test/usp-preservative-challenge-test-personal-care-products and the “Modified Kirby Bauer Method,” available at http://helid.digicollection.org/en/d/Jwho01e/4.10.6.html.

As used in the specification and the appended claims, the singular forms “a,” “an” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to systems or processes, the term can mean within an order of magnitude, preferably within 5-fold, and more preferably within 2-fold, of a value.

### Fibers

The nonwoven material of the presently disclosed subject matter comprises one or more types of fibers. For example, the fibers can be natural, synthetic, or a mixture thereof. In certain embodiments, the nonwoven material can contain two or more layers, where each layer contains a specific fibrous content, which can include one or more of synthetic fibers, cellulose fibers, or a mixture thereof.

### Modified Cellulose Fibers

The presently disclosed subject matter contemplates the use of cellulose-based fibers that are chemically modified. Any cellulose fibers known in the art, including cellulose fibers of any natural origin, such as those derived from wood pulp or regenerated cellulose, can be used in a cellulosic layer.

In certain embodiment, cellulose fibers include, but are not limited to, digested fibers, such as kraft, prehydrolyzed kraft, soda, sulfite, chemi-thermal mechanical, and thermo-mechanical treated fibers, derived from softwood, hardwood or cotton linters. In other embodiments, cellulose fibers include, but are not limited to, kraft digested fibers, including prehydrolyzed kraft digested fibers. Non-limiting examples of cellulose fibers suitable for use in this subject matter are the cellulose fibers derived from softwoods, such as pines, firs, and spruces. Other suitable cellulose fibers include, but are not limited to, those derived from Esparto grass, bagasse, kemp, flax, hemp, kenaf, and other lignaceous and cellulosic fiber sources. Suitable cellulose fibers include, but are not limited to, bleached Kraft southern pine fibers sold under the trademark FOLEY FLUFFS® (Buckeye Technologies Inc., Memphis, Tenn.). Additionally, fibers sold under the trademark CELLU TISSUE® (e.g., Grade 3024) (Clearwater Paper Corporation, Spokane, Wash.) are utilized in certain aspects of the disclosed subject matter. The nonwoven materials of the disclosed subject matter can also include, but are not limited to, a commercially available bright fluff pulp including, but not limited to, southern softwood fluff pulp (such as Treated FOLEY FLUFFS®) northern softwood sulfite pulp (such as T 730 from Weyerhaeuser), or hardwood pulp (such as eucalyptus). While certain pulps may be preferred based on a variety of factors, any absorbent fluff pulp or mixtures thereof can be used. Non-limiting examples of additional pulps are FOLEY FLUFFS® FFTAS (also known as FFTAS or Buckeye Technologies FFT-AS pulp), and Weyco CF401.

As embodied herein, the cellulose fibers can be chemically treated with a compound comprising a polyvalent metal ion, e.g., a polyvalent cation. Such chemically modified fibers are described, for the purpose of illustration and not limitation, in U.S. Pat. Nos. 6,562,743 and 8,946,100, the contents of which are hereby incorporated by reference in their entireties. The chemically modified cellulose fibers can optionally be associated with a weak acid.

The chemically modified cellulose fiber can be treated with from about 0.1 weight percent to about 20 weight percent of the polyvalent cation-containing compound, based on the dry weight of the untreated fiber, desirably with from about 2 weight percent to about 12 weight percent of the polyvalent metal-containing compound, and preferably with from about 3 weight percent to about 8 weight percent of the polyvalent cation-containing compound, based on the dry weight of the untreated fiber.

In particular embodiments, the chemically modified cellulose fiber is treated with an aluminum-containing compound. The aluminum-containing compound can be precipitated onto the surface of the modified cellulose fibers such that it does not leach when the fibers are stored in a liquid environment. For example, in certain embodiments, when the chemically modified cellulose fibers are used in a nonwoven material that is stored in a liquid environment, the aluminum-containing compound remains fixed to the fibers and does not leach. In certain embodiments, the liquid environment can be a solution comprising a sanitizing agent, as described in greater detail below. In certain embodiments, the amount of the aluminum-containing compound leached to the liquid environment can be less than about 200 ppm, less than about 100 ppm, or less than about 50 ppm.

Any polyvalent metal salt including transition metal salts may be used, provided that the compound is capable of increasing the stability of the cellulose fiber in an alkaline environment. Examples of suitable polyvalent metals include beryllium, magnesium, calcium, strontium, barium, titanium, zirconium, vanadium, chromium, molybdenum, tungsten, manganese, iron, cobalt, nickel, copper, zinc, aluminum and tin. Preferred ions include aluminum, iron and tin. The preferred metal ions have oxidation states of +3 or +4. In certain embodiments, the polyvalent metal is aluminum. Any salt containing the polyvalent metal ion may be employed. Examples of suitable inorganic salts of the above metals include chlorides, nitrates, sulfates, borates, bromides, iodides, fluorides, nitrides, perchlorates, phosphates, hydroxides, sulfides, carbonates, bicarbonates, oxides, alkoxides phenoxides, phosphites, and hypophosphites. Examples of suitable organic salts of the above metals include formates, acetates, butyrates, hexanoates, adipates, citrates, lactates, oxalates, propionates, salicylates, glycinates, tartrates, glycolates, sulfonates, phosphonates, glutamates, octanoates, benzoates, gluconates, maleates, succinates, and 4,5-dihydroxy-benzene-1,3-disulfonates. In addition to the polyvalent metal salts, other compounds such as complexes of the above salts include amines, ethylenediaminetetra-acetic acid (EDTA), diethylenetriaminepenta-acetic acid (DIPA), nitrilotri-acetic acid (NTA), 2,4-pentanedione, and ammonia may be used. In certain embodiments, the polyvalent metal salt is aluminum chloride, aluminum hydroxide, or aluminum sulfate. Alum is an aluminum sulfate salt which is soluble in water. In an aqueous slurry of cellulose, some of the alum will penetrate the fiber cell wall, but since the concentration of ions is low, most of the dissolved aluminum salt will be outside the fiber. When the pH is adjusted to precipitate aluminum hydroxide, most of the precipitate adheres to the fiber surface.

In certain embodiments, the chemically modified cellulose fiber has an acid bound or otherwise associated with it. A variety of suitable acids may be employed, although the acid preferably should have a low volatility. In certain embodiments, the acid is a weak acid. For example, and not limitation, suitable acids include inorganic acids such as sodium bisulfate, sodium dihydrogen phosphate and disodium hydrogen phosphate, and organic acids such as formic, acetic, aspartic, propionic, butyric, hexanoic, benzoic, gluconic, oxalic, malonic, succinic, glutaric, tartaric, maleic, malic, phthallic, sulfonic, phosphonic, salicylic, glycolic, citric, butanetetracarboxylic acid (BTCA), octanoic, polyacrylic, polysulfonic, polymaleic, and lignosulfonic acids, as well as hydrolyzed-polyacrylamide and CMC (carboxymethylcellulose). Among the carboxylic acids, acids with two carboxyl groups are preferred, and acids with three carboxyl groups are more preferred. In certain embodiments, the acid is citric acid.

In general, the amount of acid employed can depend on the acidity and the molecular weight of the acid. In certain embodiments, the acid comprises from about 0.5 weight percent of the fibers to about 10 weight percent of the fibers. As used herein, the “weight percent of the fibers” refers to the weight percent of dry fiber treated with the polyvalent metal containing compound, i.e., based on the dry weight of the treated fibers. For example, in certain embodiments, the acid is citric acid in an amount of from about 0.5 weight percent to about 3 weight percent of the fibers. A preferred combination is an aluminum-containing compound and citric acid. For the chemically treated fibers of this aspect of this invention, it is desirable that the weak acid content of the chemically treated fibers is from about 0.5 weight percent to about 10 weight percent based on the dry weight of the treated fibers, more desirably, from about 0.5 weight percent to about 5 weight percent based on the dry weight of the treated fibers, and, preferably, from about 0.5 weight percent to about 3 weight percent based on the dry weight of the treated fibers.

Alternatively, in certain embodiments, a buffer salt can be used instead of a weak acid in combination with the polyvalent metal-containing compound. Any buffer salt that in water would provide a solution having a pH of less than about 7 is suitable. For example, and not limitation, suitable buffer salts include sodium acetate, sodium oxalate, sodium tartrate, sodium phthalate, sodium dihydrogen phosphate, disodium hydrogen phosphate and sodium borate. Buffer salts may be used in combination with their acids in a combination that in water would provide a solution having a pH of less than about 7, for example, oxalic acid/sodium oxalate, tartaric acid/sodium tartrate, sodium phthalate/phthalic acid, and sodium dihydrogen phosphate/disodium hydrogen phosphate.

In further variations, the polyvalent metal-containing compound can be used in combination with an insoluble metal hydroxide, such as, for example, magnesium hydroxide, or in combination with one or more alkali stable anti-oxidant chemicals or alkali stable reducing agents that would inhibit fiber degradation in an alkaline oxygen environment. Examples include inorganic chemicals such as sodium sulfite, and organic chemicals such as hydroquinone.

For the chemically modified cellulose fibers, it is desirable that the buffer salt content, the buffer salt weak acid combination content, the insoluble metal hydroxide content and/or the antioxidant content of the chemically treated fibers is from about 0.5 weight percent to about 10 weight percent based on the dry weight of the treated fibers, more desirably, from about 0.5 weight percent to about 5 weight percent based on the dry weight of the treated fibers, and, preferably, from about 0.5 weight percent to about 3 weight percent based on the dry weight of the treated fibers.

In certain embodiments, reducing agents can be applied to the modified cellulose fibers to maintain desired levels of fiber brightness, by reducing brightness reversion. The addition of acidic substances may cause browning of fibers when heated during processing of webs containing the fibers. Reducing agents counter the browning of the fibers. The reducing agent can also bond to the fibers. Suitable reducing agents include sodium hypophosphite, sodium bisulfate, and mixtures thereof.

The fibers suitable for use in the practice of this invention may be treated in a variety of ways to provide the polyvalent metal ion-containing compound in close association with the fibers. A preferred method is to introduce the compound in solution with the fibers in slurry form and cause the compound to precipitate onto the surface of the fibers. Alternatively, the fibers may be sprayed with the compound in aqueous or non-aqueous solution or suspension. The fibers may be treated while in an individualized state, or in the form of a web. For example, the compound may be applied directly onto the fibers in powder or other physical form. Whatever method is used, however, it is preferred that the compound remain bound to the fibers, such that the compound is not dislodged during normal physical handling of the fiber before contact of the fiber with liquid.

In a preferred embodiment, the treated fibers of the present invention are made from cellulose fiber known as FOLEY FLUFFS® from Buckeye Technologies Inc. (Memphis, Tenn.). The pulp is slurried, the pH is adjusted to about 4.0, and aluminum sulfate (Al₂(SO₄)₃) in aqueous solution is added to the slurry. The slurry is stirred and the consistency reduced. Under agitation, the pH of the slurry is increased to approximately 5.7. The fibers are then formed into a web or sheet, dried, and, optionally, sprayed with a solution of citric acid at a loading of about 2.5 weight percent of the fibers. The web is then packaged and shipped to end users for further processing, including fiberization to form individualized fibers useful in the manufacture of various products.

In another preferred embodiment, the treated fibers of the present invention are made from cellulose fiber obtained from Buckeye Technologies Inc. (Memphis, Tenn.). The pulp is slurried, the pH is adjusted to about 4.0, and aluminum sulfate (Al₂(SO₄)₃) in aqueous solution is added to the slurry. The slurry is stirred and the consistency reduced. Under agitation, the pH of the slurry is increased to approximately 5.7. The fibers are then formed into a web or sheet, dried, and sprayed with a solution of sodium oleate at a loading of about 1.0 weight percent of the fibers. The web is then packaged and shipped to end users for further processing, including re-slurrying to form a web useful in the manufacture of filtration products. If a reducing agent is to be applied, preferably it is applied before a drying step and following any other application steps. The reducing agent may be applied by spraying, painting or foaming.

Metal ion content, including aluminum or iron content, in pulp samples can be determined by wet ashing (oxidizing) the sample with nitric and perchloric acids in a digestion apparatus. A blank is oxidized and carried through the same steps as the sample. The sample is then analyzed using an inductively coupled plasma spectrophotometer, such as, for example, a Perkin-Elmer ICP 6500. From the analysis, the ion content in the sample can be determined in parts per million. The polyvalent cation content desirably is from about 0.1 weight percent to about 5.0 weight percent, based on the dry weight of the treated fibers, more desirably, from about 0.1 weight percent to about 3.0 weight percent, based on the dry weight of the treated fibers, preferably from about 0.1 weight percent to about 1.5 weight percent, based on the dry weight of the treated fibers, more preferably, from about 0.2 weight percent to about 0.9 weight percent, based on the dry weight of the treated fibers, and more preferably from about 0.3 weight percent to about 0.8 weight percent, based on the dry weight of the treated fibers.

Without intending to be bound by theory, it is believed that by this process, the soluble Al₂(SO₄)₃ introduced to the pulp slurry is converted to insoluble Al(OH)₃ as the pH is increased. The insoluble aluminum hydroxide precipitates onto the fiber. Thus, the resultant chemically treated cellulose fibers are coated with Al(OH)₃ or contain the insoluble metal within the fiber interior.

The sodium oleate sprayed onto the web containing the fibers dries on the fibers. When the Al(OH)₃-oleate treated fibers are formed into a filter based sheet, the aluminum and oleate ions create a hydrophobic environment in addition to increasing the wet strength of the structure. These results are exemplified in the procedures set forth below.

In another embodiment, hydrated aluminum sulfate and sodium oleate are sprayed on the fiber after the drying section of a paper machine. In another embodiment, hydrated aluminum sulfate and sodium oleate are precipitated onto the fiber in the wet end section of a paper machine. In another embodiment, hydrated aluminum sulfate and sodium hypophosphite are sprayed on the fiber prior to the pressing stage, and sodium oleate is sprayed after drying. In another embodiment, hydrated aluminum sulfate, sodium hypophosphite and sodium oleate are sprayed on the fiber prior to the pressing stage. In yet another embodiment, hydrated aluminum sulfate is precipitated onto the fiber, hydrated aluminum and sodium hypophosphite are sprayed on the fiber prior to pressing, and sodium oleate is sprayed on the fiber after drying. In another embodiment, hydrated aluminum sulfate is precipitated onto the fiber and sodium oleate is sprayed on the fiber prior to the pressing stage.

Various materials, structures and manufacturing processes can be used in connection with the presently disclosed modified cellulose fibers, for example and not limitation, as described in U.S. Pat. Nos. 6,241,713, 6,353,148, 6,353,148, 6,171,441, 6,159,335, 5,695,486, 6,344,109, 5,068,079, 5,492,759, 5,269,049, 5,601,921, 5,693,162, 5,922,163, 6,007,653, 6,355,079, 6,403,857, 6,479,415, 6,562,742, 6,562,743, 6,559,081, 6,495,734, 6,420,626, and 8,946,100, and in U.S. Patent Publication Nos. US2004/0208175 and US2002/0013560, all of which are hereby incorporated by reference in their entireties.

In certain embodiments, chemically modified cellulose such as cross-linked cellulose fibers and highly purified cellulose fibers can be used. In particular embodiments, the modified cellulose fibers are crosslinked cellulose fibers. In certain embodiments, the modified cellulose fibers comprise a polyhydroxy compound. Non-limiting examples of polyhydroxy compounds include glycerol, trimethylolpropane, pentaerythritol, polyvinyl alcohol, partially hydrolyzed polyvinyl acetate, and fully hydrolyzed polyvinyl acetate.

In certain embodiments, the modified cellulose pulp fibers have been softened or plasticized to be inherently more compressible than unmodified pulp fibers. The same pressure applied to a plasticized pulp web will result in higher density than when applied to an unmodified pulp web. Additionally, the densified web of plasticized cellulose fibers is inherently softer than a similar density web of unmodified fiber of the same wood type. Softwood pulps may be made more compressible using cationic surfactants as debonders to disrupt interfiber associations. Use of one or more debonders facilitates the disintegration of the pulp sheet into fluff in the airlaid process. Examples of debonders include, but are not limited to, those disclosed in U.S. Pat. Nos. 4,432,833, 4,425,186 and 5,776,308, all of which are hereby incorporated by reference in their entireties. One example of a debonder-treated cellulose pulp is FFLE+. Plasticizers for cellulose, which can be added to a pulp slurry prior to forming wetlaid sheets, can also be used to soften pulp, although they act by a different mechanism than debonding agents. Plasticizing agents act within the fiber, at the cellulose molecule, to make flexible or soften amorphous regions. The resulting fibers are characterized as limp. Since the plasticized fibers lack stiffness, the comminuted pulp is easier to densify compared to fibers not treated with plasticizers. Plasticizers include, but are not limited to, polyhydric alcohols such as glycerol, low molecular weight polyglycol such as polyethylene glycols, and polyhydroxy compounds. These and other plasticizers are described and exemplified in U.S. Pat. Nos. 4,098,996, 5,547,541 and 4,731,269, all of which are hereby incorporated by reference in their entireties. Ammonia, urea, and alkylamines are also known to plasticize wood products, which mainly contain cellulose (A. J. Stamm, Forest Products Journal 5(6):413, 1955, hereby incorporated by reference in its entirety).

### Synthetic Fibers In certain embodiments, the nonwoven material can include one or more synthetic layers. Any synthetic fibers known in the art can be used in a synthetic layer.

In one embodiment, the synthetic fibers comprise bicomponent and/or mono-component fibers. Bicomponent fibers having a core and sheath are known in the art. Many varieties are used in the manufacture of nonwoven materials, particularly those produced for use in airlaid techniques. Various bicomponent fibers suitable for use in the presently disclosed subject matter are disclosed in U.S. Pat. Nos. 5,372,885 and 5,456,982, both of which are hereby incorporated by reference in their entireties. Examples of bicomponent fiber manufacturers include, but are not limited to, Trevira (Bobingen, Germany), Fiber Innovation Technologies (Johnson City, Tenn.) and ES Fiber Visions (Athens, Ga.). Bicomponent fibers can incorporate a variety of polymers as their core and sheath components. Bicomponent fibers that have a PE (polyethylene) or modified PE sheath typically have a PET (polyethylene terephthalate) or PP (polypropylene) core. In one embodiment, the bicomponent fiber has a core made of polyester and sheath made of polyethylene.

The denier of the bicomponent fiber preferably ranges from about 1.0 dpf to about 4.0 dpf, and more preferably from about 1.5 dpf to about 2.5 dpf. The length of the bicomponent fiber can be from about 3 mm to about 36 mm, preferably from about 3 mm to about 12 mm, more preferably from about 3 mm to about 10 mm. In particular embodiments, the length of the bicomponent fiber is from about 2 mm to about 8 mm, or about 4 mm, or about 6 mm.

Bicomponent fibers are typically fabricated commercially by melt spinning. In this procedure, each molten polymer is extruded through a die, for example, a spinneret, with subsequent pulling of the molten polymer to move it away from the face of the spinneret. This is followed by solidification of the polymer by heat transfer to a surrounding fluid medium, for example chilled air, and taking up of the now solid filament. Non-limiting examples of additional steps after melt spinning can also include hot or cold drawing, heat treating, crimping and cutting. This overall manufacturing process is generally carried out as a discontinuous two-step process that first involves spinning of the filaments and their collection into a tow that comprises numerous filaments. During the spinning step, when molten polymer is pulled away from the face of the spinneret, some drawing of the filament does occur which can also be called the draw-down. This is followed by a second step where the spun fibers are drawn or stretched to increase molecular alignment and crystallinity and to give enhanced strength and other physical properties to the individual filaments. Subsequent steps can include, but are not limited to, heat setting, crimping and cutting of the filament into fibers. The drawing or stretching step can involve drawing the core of the bicomponent fiber, the sheath of the bicomponent fiber or both the core and the sheath of the bicomponent fiber depending on the materials from which the core and sheath are comprised as well as the conditions employed during the drawing or stretching process.

Bicomponent fibers can also be formed in a continuous process where the spinning and drawing are done in a continuous process. During the fiber manufacturing process, it is desirable to add various materials to the fiber after the melt spinning step at various subsequent steps in the process. These materials can be referred to as “finish” and be comprised of active agents such as, but not limited to, lubricants and anti-static agents. The finish is typically delivered via an aqueous based solution or emulsion. Finishes can provide desirable properties for both the manufacturing of the bicomponent fiber and for the user of the fiber, for example in an airlaid or wetlaid process. Numerous other processes are involved before, during and after the spinning and drawing steps and are disclosed in U.S. Pat. Nos. 4,950,541, 5,082,899, 5,126,199, 5,372,885, 5,456,982, 5,705,565, 2,861,319, 2,931,091, 2,989,798, 3,038,235, 3,081,490, 3,117,362, 3,121,254, 3,188,689, 3,237,245, 3,249,669, 3,457,342, 3,466,703, 3,469,279, 3,500,498, 3,585,685, 3,163,170, 3,692,423, 3,716,317, 3,778,208, 3,787,162, 3,814,561, 3,963,406, 3,992,499, 4,052,146, 4,251,200, 4,350,006, 4,370,114, 4,406,850, 4,445,833, 4,717,325, 4,743,189, 5,162,074, 5,256,050, 5,505,889, 5,582,913, and 6,670,035, all of which are hereby incorporated by reference in their entireties.

The presently disclosed subject matter can also include, but are not limited to, articles that contain bicomponent fibers that are partially drawn with varying degrees of draw or stretch, highly drawn bicomponent fibers and mixtures thereof. These can include, but are not limited to, a highly drawn polyester core bicomponent fiber with a variety of sheath materials, specifically including a polyethylene sheath such as Trevira T255 (Bobingen, Germany) or a highly drawn polypropylene core bicomponent fiber with a variety of sheath materials, specifically including a polyethylene sheath such as ES FiberVisions AL-Adhesion-C (Varde, Denmark). Additionally, Trevira T265 bicomponent fiber (Bobingen, Germany), having a partially drawn core with a core made of polybutylene terephthalate (PBT) and a sheath made of polyethylene can be used. The use of both partially drawn and highly drawn bicomponent fibers in the same structure can be leveraged to meet specific physical and performance properties based on how they are incorporated into the structure.

The bicomponent fibers of the presently disclosed subject matter are not limited in scope to any specific polymers for either the core or the sheath as any partially drawn core bicomponent fiber can provide enhanced performance regarding elongation and strength. The degree to which the partially drawn bicomponent fibers are drawn is not limited in scope as different degrees of drawing will yield different enhancements in performance. The scope of the partially drawn bicomponent fibers encompasses fibers with various core sheath configurations including, but not limited to concentric, eccentric, side by side, islands in a sea, pie segments and other variations. The relative weight percentages of the core and sheath components of the total fiber can be varied. In addition, the scope of this subject matter covers the use of partially drawn homopolymers such as polyester, polypropylene, nylon, and other melt spinnable polymers. The scope of this subject matter also covers multicomponent fibers that can have more than two polymers as part of the fibers structure.

In particular embodiments, the bicomponent fibers in a particular layer comprise from about 10 to about 100 percent by weight of the layer. In alternative embodiments, the bicomponent layer contains from about 10 gsm to about 50 gsm bicomponent fibers, or from about 20 gsm to about 50 gsm bicomponent fibers, or from about 30 gsm to about 40 gsm bicomponent fibers.

In particular embodiments, the bicomponent fibers are low dtex staple bicomponent fibers in the range of about 0.5 dtex to about 20 dtex. In certain embodiments, the dtex value is 5.7 dtex. In other certain embodiments, the dtex value is 1.7 dtex.

Other synthetic fibers suitable for use in various embodiments as fibers or as bicomponent binder fibers include, but are not limited to, fibers made from various polymers including, by way of example and not by limitation, acrylic, polyamides (including, but not limited to, Nylon 6, Nylon 6/6, Nylon 12, polyaspartic acid, polyglutamic acid), polyamines, polyimides, polyacrylics (including, but not limited to, polyacrylamide, polyacrylonitrile, esters of methacrylic acid and acrylic acid), polycarbonates (including, but not limited to, polybisphenol A carbonate, polypropylene carbonate), polydienes (including, but not limited to, polybutadiene, polyisoprene, polynorbomene), polyepoxides, polyesters (including, but not limited to, polyethylene terephthalate, polybutylene terephthalate, polytrimethylene terephthalate, polycaprolactone, polyglycolide, polylactide, polyhydroxybutyrate, polyhydroxyvalerate, polyethylene adipate, polybutylene adipate, polypropylene succinate), polyethers (including, but not limited to, polyethylene glycol (polyethylene oxide), polybutylene glycol, polypropylene oxide, polyoxymethylene (paraformaldehyde), polytetramethylene ether (polytetrahydrofuran), polyepichlorohydrin), polyfluorocarbons, formaldehyde polymers (including, but not limited to, urea-formaldehyde, melamine-formaldehyde, phenol formaldehyde), natural polymers (including, but not limited to, cellulosics, chitosans, lignins, waxes), polyolefins (including, but not limited to, polyethylene, polypropylene, polybutylene, polybutene, polyoctene), polyphenylenes (including, but not limited to, polyphenylene oxide, polyphenylene sulfide, polyphenylene ether sulfone), silicon containing polymers (including, but not limited to, polydimethyl siloxane, polycarbomethyl silane), polyurethanes, polyvinyls (including, but not limited to, polyvinyl butyral, polyvinyl alcohol, esters and ethers of polyvinyl alcohol, polyvinyl acetate, polystyrene, polymethylstyrene, polyvinyl chloride, polyvinyl pryrrolidone, polymethyl vinyl ether, polyethyl vinyl ether, polyvinyl methyl ketone), polyacetals, polyarylates, and copolymers (including, but not limited to, polyethylene-co-vinyl acetate, polyethylene-co-acrylic acid, polybutylene terephthalate-co-polyethylene terephthalate, polylauryllactam-block-polytetrahydrofuran), polybutylene succinate and polylactic acid based polymers.

In particular embodiments, bicomponent fibers are used in a synthetic fiber layer. In certain embodiments, the synthetic fiber layer contains from about 5 gsm to about 20 gsm synthetic fibers, or about 10 gsm to about 15 gsm synthetic fibers.

### Additives

In addition to one or more fibrous layers, the presently disclosed nonwoven materials can further include additives. In certain embodiments, an additive can be applied to at least a portion of at least one outer layer of the nonwoven material. In certain embodiments, the nonwoven material can include a binder. In particular embodiments, the binder is a thermoplastic binder. The nonwoven materials can further be treated with a liquid, such as a cleaning composition comprising a sanitizing agent, such as a cationic compound. The sanitizing agent can be bound to the modified cellulose fibers.

In certain embodiments, the nonwoven material can further contain other additives. In certain embodiments, the nonwoven material can include a dye or pigment. For example, in particular embodiments, the nonwoven material can include an anionic pigment. Additionally or alternatively, in certain embodiments, the nonwoven material can contain a lotion.

In certain embodiments, the nonwoven material can include an anti-microbial agent as an additive. The anti-microbial agent can be added to the nonwoven material prior to the sanitizing agent, and can be present in the nonwoven material when the nonwoven material is in dry form. For the purpose of example, and not limitation, suitable anti-microbial agents include: poly-amine compounds, such as Chitosan; essential oils, such as cinnamon oil and thyme oil; organic acids, such as lactic acid and citric acid; and certain aluminum compounds, as known in the art.

### Binders

Suitable binders include, but are not limited to, liquid binders and powder binders. Non-limiting examples of liquid binders include emulsions, solutions, or suspensions of binders. Non-limiting examples of binders include polyethylene powders, copolymer binders, vinylacetate ethylene binders, styrene-butadiene binders, urethanes, urethane-based binders, acrylic binders, thermoplastic binders, natural polymer based binders, and mixtures thereof. In certain embodiments, the binder is a cationic binder. For example, and not limitation, in certain embodiments, the binder is Duroset Elite Plus 299A.

For example, suitable binders include, but are not limited to, copolymers, vinylacetate ethylene (“VAE”) copolymers which can have a stabilizer, such as Wacker Vinnapas 192, Wacker Vinnapas EF 539, Wacker Vinnapas EP907, Wacker Vinnapas EP129, Celanese Dur-O-Set E130, Celanese Dur-O-Set Elite 130 25-1813 and Celanese Dur-O-Set TX-849, Celanese Dur-O-Set 25-010A, Celanese 75-524A, polyvinyl alcohol-polyvinyl acetate blends such as Wacker Vinac 911, vinyl acetate homopolymers, polyvinyl amines such as BASF Luredur, acrylics, cationic acrylamides, polyacryliamides such as Bercon Berstrength 5040 and Bercon Berstrength 5150, hydroxyethyl cellulose, starch such as National Starch CATO RTM 232, National Starch CATO RTM 255, National Starch Optibond, National Starch Optipro, or National Starch OptiPLUS, guar gum, styrene-butadienes, urethanes, urethane-based binders, thermoplastic binders, acrylic binders, and carboxymethyl cellulose such as Hercules Aqualon CMC. In certain embodiments, the binder is a natural polymer based binder. Non-limiting examples of natural polymer based binders include polymers derived from starch, cellulose, chitin, and other polysaccharides.

In certain embodiments, the binder is water-soluble. In one embodiment, the binder is a vinylacetate ethylene copolymer. One non-limiting example of such copolymers is EP907 (Wacker Chemicals, Munich, Germany). Vinnapas EP907 can be applied at a level of about 10% solids incorporating about 0.75% by weight Aerosol OT (Cytec Industries, West Paterson, N.J.), which is an anionic surfactant. Other classes of liquid binders such as styrene-butadiene and acrylic binders can also be used.

In certain embodiments, the binder is not water-soluble. Examples of these binders include, but are not limited to, Vinnapas 124 and 192 (Wacker) which can have an opacifier and whitener, including, but not limited to, titanium dioxide, dispersed in the emulsion. Other binders include, but are not limited to, Celanese Emulsions (Bridgewater, N.J.) Elite 22 and Elite 33.

In certain embodiments, the binder is a thermoplastic binder. Such thermoplastic binders include, but are not limited to, any thermoplastic polymer which can be melted at temperatures which will not extensively damage the cellulose fibers.

Preferably, the melting point of the thermoplastic binding material will be less than about 175° C. Examples of suitable thermoplastic materials include, but are not limited to, suspensions of thermoplastic binders and thermoplastic powders. In particular embodiments, the thermoplastic binding material can be, for example, polyethylene, polypropylene, polyvinylchloride, and/or polyvinylidene chloride.

In particular embodiments, the vinylacetate ethylene binder is non-crosslinkable. In one embodiment, the vinylacetate ethylene binder is crosslinkable. In certain embodiments, the binder is WD4047 urethane-based binder solution supplied by HB Fuller. In one embodiment, the binder is Michem Prime 4983-45N dispersion of ethylene acrylic acid (“EAA”) copolymer supplied by Michelman. In certain embodiments, the binder is Dur-O-Set Elite 22LV emulsion of VAE binder supplied by Celanese Emulsions (Bridgewater, N.J.). As noted above, in particular embodiments, the binder is crosslinkable. It is also understood that crosslinkable binders are also known as permanent wet strength binders. A permanent wet-strength binder includes, but is not limited to, Kymene® (Hercules Inc., Wilmington, Del.), Parez® (American Cyanamid Company, Wayne, N.J.), Wacker Vinnapas or AF192 (Wacker Chemie AG, Munich, Germany), or the like. Various permanent wet-strength agents are described in U.S. Pat Nos. 2,345,543, 2,926,116, and 2,926,154, the disclosures of which are incorporated by reference in their entirety. Other permanent wet-strength binders include, but are not limited to, polyamine-epichlorohydrin, polyamide epichlorohydrin or polyamide-amine epichlorohydrin resins, which are collectively termed “PAE resins”. Non-limiting exemplary permanent wet-strength binders include Kymene 557H or Kymene 557LX (Hercules Inc., Wilmington, Del.) and have been described in U.S. Pat. Nos. 3,700,623 and 3,772,076, which are incorporated herein in their entirety by reference thereto.

Alternatively, in certain embodiments, the binder is a temporary wet-strength binder. The temporary wet-strength binders include, but are not limited to, Hercobond® (Hercules Inc., Wilmington, Del.), Parez® 750 (American Cyanamid Company, Wayne, N.J.), Parez® 745 (American Cyanamid Company, Wayne, N.J.), or the like. Other suitable temporary wet-strength binders include, but are not limited to, dialdehyde starch, polyethylene imine, mannogalactan gum, glyoxal, and dialdehyde mannogalactan. Other suitable temporary wet-strength agents are described in U.S. Pat Nos. 3,556,932, 5,466,337, 3,556,933, 4,605,702, 4,603,176, 5,935,383, and 6,017,417, all of which are incorporated herein in their entirety by reference thereto.

In particular embodiments, the binder can be Dur-O-Set 25-010A, Vinnapas 192, Vinnapas RB18, Vinnapas RBG1, or a combination thereof. In certain embodiments, binders are applied as emulsions in amounts ranging from about 1 gsm to about 4 gsm, or from about 1 gsm to about 2 gsm, or from about 2 gsm to about 3 gsm.

The binder can be applied to one side of a fibrous layer, preferably an externally facing layer. Alternatively, binder can be applied to both sides of a layer, in equal or disproportionate amounts. In certain embodiments, the binder can be present in the nonwoven material in an amount of from about 1 wt-% to about 50 wt-%, or from about 2 wt-% to about 30 wt-%, or from about 3 wt-% to about 25 wt-%, or from about 5 wt-% to about 20 wt-%, or from about 6 wt-% to about 15 wt-%.

### Sanitizing Agents

As embodied herein, the nonwoven material can further include a sanitizing agent. In certain embodiments, the sanitizing agent can be present in a liquid solvent, for example, a water or an alcohol For example, the sanitizing agent can be present in a solution in an amount ranging from about 0.001 wt-% to about 20 wt-%, or from about 0.01 wt-% to about 10 wt-%, or from about 0.05 wt-% to about 5 wt-%, or from about 0.1 wt-% to about 5 wt-%, or from about 0.5 wt-% to about 3 wt-%, or from about 0.7 wt-% to about 2 wt-%, or from about 0.9 wt-% to about 1 wt-% of the solution. The nonwoven material can be treated with a solution comprising the sanitizing agent in order to apply the sanitizing agent. The sanitizing agent can thereby bond to the modified cellulose fibers. As described above, the modified cellulose fibers can be treated with a cation-containing compound, e.g., aluminum, such that the compound does not leach to the solution comprising the sanitizing agent.

Suitable sanitizing agents include cationic compounds. For purpose of example and not limitation, the cationic compound can be a quaternary ammonium compound. In their cation form, quaternary ammonium compounds have the formula NR₄⁺. The R groups can be alkyl or aryl groups. The cation can form a salt (NR₄⁺X⁻), for example, with any counter-ion that forms a salt soluble in the desired solvent. In certain embodiments, the quaternary ammonium compound is a halide salt, such as a chloride. Suitable quaternary ammonium compounds include alkyl ammonium halides, alkyl aryl ammonium halides, n-alkyl pyridinium halides, and the like. In certain embodiments, suitable quaternary ammonium compounds can include amide, ether, or ester linkages. In particular embodiments, the quaternary ammonium compound can be one or more of octyl decyl dimethyl ammonium chloride, dioctyl dimethyl ammonium chloride, didecyl dimethyl ammonium chloride, and a C₁₂-C₁₆ alkyl dimethyl benzyl ammonium chloride. In particular embodiments, the sanitizing agent is dioctyldecyl dimethyl ammonium chloride, octyl decyl dimethyl ammonium chloride, alkyl dimethyl benzyl ammonium chloride, or a combination thereof.

In certain embodiments, a liquid solvent containing the sanitizing agent is added to the nonwoven material in an amount corresponding to the dry weight of the nonwoven material. For example, and not limitation, the weight of liquid solvent applied to the nonwoven material can range from about 2 times the dry weight of the nonwoven material to about 5 times the weight of the nonwoven material.

### Nonwoven Materials

The presently disclosed subject matter provides for nonwoven materials having at least one layer. In certain embodiments, a nonwoven material contains at least two layers, wherein each layer comprises a specific fibrous content. In specific embodiments, the nonwoven material contains at least one layer comprising modified cellulose fibers. In particular embodiments, the nonwoven material contains only modified cellulose fibers. In other embodiments, one or more layers of the nonwoven material further includes synthetic fibers. In particular embodiments, a synthetic fiber layer can include bicomponent fibers. In certain embodiments, the nonwoven material is a single layer, comprising both modified cellulose fibers and synthetic fibers. In particular embodiments, the synthetic fibers are bicomponent fibers. In other certain embodiments, the nonwoven material is a single layer having only modified cellulose fibers. In certain embodiments, the nonwoven material can include both modified and unmodified cellulose fibers.

In certain embodiments, the nonwoven material has at least two layers, wherein each layer comprises a specific fibrous content. In specific embodiments, the nonwoven material contains a modified cellulose fiber layer and a synthetic fiber layer. In certain embodiments, one or more layers are bonded on at least a portion of at least one of their outer surfaces with binder. It is not necessary that the binder chemically bond with a portion of the layer, although it is preferred that the binder remain associated in close proximity with the layer, by coating, adhering, precipitation, or any other mechanism such that it is not dislodged from the layer during normal handling of the layer. For convenience, the association between the layer and the binder discussed above can be referred to as the bond, and the compound can be said to be bonded to the layer.

In a particular embodiment, a first layer is composed of bicomponent fibers. A second layer disposed adjacent to the first layer is composed of modified cellulose fibers. In certain embodiments, the second layer is composed of both modified cellulose and synthetic fibers, e.g., bicomponent fibers. In certain embodiments, the second layer is coated with binder on its outer surface.

In certain embodiments, the first layer contains from about 10 gsm to about 50 gsm of bicomponent fibers. In certain embodiments, the second layer contains from about 10 gsm to about 100 gsm of modified cellulose fibers.

In certain embodiments, the nonwoven material has at least two layers, wherein each layer comprises modified cellulose fibers. One or more layers can further include synthetic fibers, such as bicomponent fibers. One or more layers can be bonded on at least a portion of at least one of their outer surfaces with binder.

In another embodiment, the first layer is composed of both modified cellulose fibers and synthetic fibers. A second layer disposed adjacent to the first layer is also composed of modified cellulose fibers and synthetic fibers. Each layer can contain from about 10 gsm to about 90 gsm, or from about 10 gsm to about 50 gsm of modified cellulose fibers. Each layer can contain from about 1 gsm to about 50 gsm, or from about 5 gsm to about 15 gsm of synthetic fibers. The first and second layers can have the same composition, or different compositions. In certain embodiments, the synthetic fibers can be bicomponent fibers.

In another embodiment, the nonwoven material has at least three layers or at least four layers, wherein each layer has a specific fibrous content. At least one layer can comprise modified cellulose fibers. In certain embodiments, each layer includes modified cellulose fibers. Optionally, additional layers may contain modified cellulose fibers and/or synthetic fibers. One or more layers can further include synthetic fibers, such as bicomponent fibers. One or more layers can be bonded on at least a portion of at least one of their outer surfaces with binder.

In certain embodiments of the presently disclosed subject matter, at least a portion of at least one outer layer is coated with binder. In particular embodiments of the disclosed subject matter, at least a portion of an outer layer is coated with binder in an amount ranging from about 1 gsm to about 4 gsm, or from about 1 gsm to about 2 gsm, or from about 2 gsm to about 3 gsm. In particular embodiments of the disclosed subject matter, at least a portion of an outer layer is coated with binder in an amount ranging from about 1 gsm to about 15 gsm, or from about 2 gsm to about 10 gsm, or from about 3 gsm to about 8 gsm.

In certain embodiments, the range of basis weight of the modified cellulose fibers in a layer containing modified cellulose fibers can be from about 20 gsm to about 100 gsm, or from about 40 gsm to about 80 gsm, or from about 50 gsm to about 70 gsm. Modified cellulose fibers can be present in a particular layer in an amount of from about 50 wt-% to about 100 wt-%, or from about 60 wt-% to about 95 wt-%, or from about 70 wt-% to about 95 wt-%, or from about 75 wt -% to about 90 wt-%. In particular embodiments, a layer can comprise 100 wt-% modified cellulose fibers.

In certain embodiments, the range of basis weight of the synthetic fibers in a layer containing synthetic fibers can be from about 1 gsm to about 100 gsm, or from about 5 gsm to about 50 gsm, or from about 5 gsm to about 30 gsm, or from about 5 gsm to about 25 gsm, or from about 10 gsm to about 20 gsm. Synthetic fibers, e.g., bicomponent fibers, can be present in a particular layer in an amount of from about 5 wt-% to about 50 wt-%, or from about 5 wt-% to about 40 wt-%, or from about 5 wt-% to about 30 wt-%, or from about 10 wt -% to about 25 wt-%, or from about 15 wt-% to about 20 wt-%. Alternatively, a layer can comprise 100 wt-% bicomponent fibers.

In certain embodiments of the nonwoven material, the range of the basis weight in a first layer is from about 5 gsm to about 100 gsm, or from about 5 gsm to about 50 gsm, or from about 20 gsm to about 40 gsm. The range of the basis weight in a second layer is from about 5 gsm to about 100 gsm, or from about 5 gsm to about 50 gsm, or from about 10 gsm to about 40 gsm. The first layer and the second layer can have the same basis weight or different basis weights. If additional layers are present, the basis weight of each ranges from about 5 gsm to about 100 gsm, or from about 5 gsm to about 50 gsm, or from about 10 gsm to about 40 gsm.

### Features of Nonwoven Material

In certain embodiments of the nonwoven material, the range of basis weight of the overall structure is from about 5 gsm to about 300 gsm, or from about 5 gsm to about 250 gsm, or from about 10 gsm to about 250 gsm, or from about 20 gsm to about 200 gsm, or from about 30 gsm to about 200 gsm, or from about 40 gsm to about 200 gsm, or from about 40 gsm to about 150 gsm, or from about 40 gsm to about 100 gsm. In particular embodiments, the basis weight of the overall structure is about 30 gsm, about 40 gsm, about 50 gsm, about 60 gsm, about 70 gsm, about 80 gsm, about 100 gsm, about 200 gsm, or about 400 gsm.

The caliper of the nonwoven material refers to the caliper of the entire material. In certain embodiments, the caliper of the material ranges from about 0.3 to about 4.0 mm, or from about 0.3 to about 3.0 mm, or from about 0.3 to about 2.0 mm, or from about 0.5 mm to about 1.5 mm, or from about 0.7 mm to about 1.0 mm. In particular embodiments, the caliper of the material is about 0.95 mm.

In certain embodiments, the nonwoven material can include from about 0 wt-% to about 99 wt-%, or from about 5 wt-% to about 95 wt-%, or from about 10 wt-% to about 90 wt-%, or from about 30 wt-% to about 80 wt-% of modified cellulose fibers based on the total weight of the nonwoven material. In certain embodiments, the nonwoven material can include from about 0 wt-% to about 99 wt-%, or from about 5 wt-% to about 95 wt-%, or from about 10 wt-% to about 90 wt-%, or from about 20 wt-% to about 70 wt-% of synthetic fibers. All or a portion of the synthetic fibers can be bicomponent fibers. In certain embodiments, the nonwoven material can include from about 2 wt-% to about 30 wt-%, or from about 2 wt-% to about 20 wt-%, or from about 2 wt-% to about 10 wt-% of a binder.

The absorbency of a nonwoven material refers to its ability to absorb moisture. The absorbency can be measured based on the mass of absorbed liquid as compared to the mass of the nonwoven material (g/g) over a particular time period. In certain embodiments, the nonwoven materials can have an absorbency of greater than about 5 g/g, greater than about 6 g/g, greater than about 7 g/g, or greater than about 7.5 g/g as measured according to WSP 10.010.1.R3.

In certain embodiments, the nonwoven material can have a cross-direction wet (CDW) tensile strength of greater about 200 g/inch, greater than about 400 g/inch, greater than about 600 g/inch, greater than about 800 g/inch, or greater than about 1000 g/inch. As embodied herein, CDW tensile strength can be measured using standard INDA methods, such as WSP 110.4.RO. In certain embodiments, the CDW tensile strength can be tested immediately after soaking the nonwoven material for a period of time in a liquid, e.g., a solution including a sanitizing agent. Alternatively, the CDW tensile strength can be testing after aging the nonwoven material in a liquid.

In certain embodiments, the nonwoven material can have a machine-direction dry (MDD) tensile strength of greater than about 300 g/inch, greater than about 500 g/inch, greater than about 800 g/inch, greater than about 1000 g/inch, greater than about 1200 g/inch, or greater than about 1500 g/inch. As embodied herein, MDD tensile strength can be measured using standard INDA methods, for example WSP 110.4.RO.

In embodiments where the nonwoven material comprises a carrier composition and is treated with a solution comprising the sanitizing agent, the material can have improved release of the sanitizing agent as it releases the solution. For example, in certain embodiments the materials can release a certain amount of a quaternary ammonium compound with the solution as the solution is released, for example, when wrung, squeezed, or used to clean a surface. This amount of the quaternary ammonium compound can be termed quat depletion, and can be measured based on the weight percentage of the quaternary ammonium compound in the released solution. Quat depletion can depend on the original amount of the quaternary ammonium compound in the solution prior to treatment of the nonwoven material, and can be reduced by the amount of the quaternary ammonium compound absorbed into the nonwoven material. Quat depletion will thus be less than or equal to the weight percentage of the quaternary ammonium compound in the solution prior to treatment the nonwoven material. Quat depletion can be determined by titration of the solution released from the nonwoven material.

In certain embodiments, quat depletion can be at least about 20%, at least about 30%, at least about 40%, at least about 45%, at least about 50%, at least about 55%, or at least about 60% of the initial amount of the quaternary ammonium compound in the solution prior to treatment of the nonwoven material. Additionally or alternatively, the amount of sanitizing agent released from the nonwoven material can be greater than a certain threshold. For example, and not limitation, the amount of sanitizing agent released can be greater than about 800 ppm, greater than about 900 ppm, greater than about 1000 ppm, greater than about 1100 ppm, or greater than about 1200 ppm.

In certain embodiments, the nonwoven material can have improved antimicrobial properties. For example, the nonwoven material containing modified cellulose fibers can have mold resistant properties. For example, when stored in an aqueous environment, such as water or an aqueous lotion solution, the nonwoven material can resist mold growth for at least about 5 days, at least about 7 days, at least about 14 days, at least about 18 days, at least about 21 days, at least about 29 days, at least about 33 days, at least about 35 days, at least about 37 days, at least about 50 days, at least about 60 days, at least about 75 days, at least about 77 days, at least about 85 days, at least about 91 days, or at least about 100 days.

Moreover, in certain embodiments, the nonwoven material containing modified cellulose fibers, as presently disclosed, can be resistant to discoloration such as browning. For example, the nonwoven material can retain its color even when exposed to an elevated temperature. The processing of nonwoven materials can include heating the materials to high temperatures, as will be explained in greater detail below, and the presently disclosed nonwoven materials can retain their color during this process.

### Methods of Modifying Cellulose Fibers

The presently disclosed modified cellulose fibers can be treated in a variety of ways to provide the polyvalent metal ion-containing compound in close association with the fibers. A preferred method is to introduce the compound in solution with the fibers in slurry form and cause the compound to precipitate onto the surface of the fibers. Alternatively, the fibers can be sprayed with the compound in aqueous or non-aqueous solution or suspension. The fibers can be treated while in an individualized state, or in the form of a web. For example, the compound can be applied directly onto the fibers in powder or other physical form. Whatever method is used, however, it is preferred that the compound remain bound to the fibers, such that the compound is not dislodged during normal physical handling of the fiber before contact of the fiber with liquid.

In a particular embodiment, the modified cellulose fibers of the present invention can be made from cellulose fiber known as FOLEY FLUFFS® from Buckeye Technologies Inc. (Memphis, Tenn.). The pulp is slurried, the pH is adjusted to about 4.0, and aluminum sulfate (Al₂(SO₄)₃) in aqueous solution is added to the slurry. The slurry is stirred and the consistency reduced. Under agitation, the pH of the slurry is increased to approximately 5.7. The fibers are then formed into a web or sheet, dried, and, optionally, sprayed with a solution of citric acid at a loading of about 2.5 weight percent of the fibers. The web is then packaged and shipped to end users for further processing, including fiberization to form individualized fibers useful in the manufacture of various products.

In another particular embodiment, the modified cellulose fibers of the present invention are made from cellulose fiber obtained from Buckeye Technologies Inc. (Memphis, Tenn.). The pulp is slurried, the pH is adjusted to about 4.0, and aluminum sulfate (Al₂(SO₄)₃) in aqueous solution is added to the slurry. The slurry is stirred and the consistency reduced. Under agitation, the pH of the slurry is increased to approximately 5.7. The fibers are then formed into a web or sheet, dried, and sprayed with a solution of sodium oleate at a loading of about 1.0 weight percent of the fibers. The web is then packaged and shipped to end users for further processing, including re-slurrying to form a web useful in the manufacture of filtration products. If a reducing agent is to be applied, preferably it is applied before a drying step and following any other application steps. The reducing agent may be applied by spraying, painting or foaming.

Without intending to be bound by theory, it is believed that by this process, the soluble (Al₂(SO₄)₃) introduced to the pulp slurry is converted to insoluble Al(OH)3 as the pH is increased. The insoluble aluminum hydroxide precipitates onto the fiber. Thus, the resultant chemically treated cellulose fibers are coated with Al(OH)₃ or contain the insoluble metal within the fiber interior.

The sodium oleate sprayed onto the web containing the fibers dries on the fibers. When the Al(OH)₃-oleate treated fibers are formed into a filter based sheet, the aluminum and oleate ions create a hydrophobic environment in addition to increasing the wet strength of the structure. These results are exemplified in the procedures set forth below.

In another embodiment, hydrated aluminum sulfate and sodium oleate are sprayed on the fiber after the drying section of a paper machine. In another embodiment, hydrated aluminum sulfate and sodium oleate are precipitated onto the fiber in the wet end section of a paper machine. In another embodiment, hydrated aluminum sulfate and sodium hypophosphite are sprayed on the fiber prior to the pressing stage, and sodium oleate is sprayed after drying. In another embodiment, hydrated aluminum sulfate, sodium hypophosphite and sodium oleate are sprayed on the fiber prior to the pressing stage. In yet another embodiment, hydrated aluminum sulfate is precipitated onto the fiber, hydrated aluminum and sodium hypophosphite are sprayed on the fiber prior to pressing, and sodium oleate is sprayed on the fiber after drying. In another embodiment, hydrated aluminum sulfate is precipitated onto the fiber and sodium oleate is sprayed on the fiber prior to the pressing stage.

### Methods of Making the Materials

A variety of processes can be used to assemble the materials used in the practice of this disclosed subject matter to produce the materials, including but not limited to, traditional dry forming processes such as airlaying and carding or other forming technologies such as spunlace or airlace. Preferably, the materials can be prepared by airlaid processes. Airlaid processes include, but are not limited to, the use of one or more forming heads to deposit raw materials of differing compositions in selected order in the manufacturing process to produce a product with distinct strata. This allows great versatility in the variety of products which can be produced.

In one embodiment, the material is prepared as a continuous airlaid web. The airlaid web is typically prepared by disintegrating or defiberizing a cellulose pulp sheet or sheets, typically by hammermill, to provide individualized fibers. Rather than a pulp sheet of virgin fiber, the hammermills or other disintegrators can be fed with recycled airlaid edge trimmings and off-specification transitional material produced during grade changes and other airlaid production waste. Being able to thereby recycle production waste would contribute to improved economics for the overall process. The individualized fibers from whichever source, virgin or recycled, are then air conveyed to forming heads on the airlaid web-forming machine. A number of manufacturers make airlaid web forming machines suitable for use in the disclosed subject matter, including Dan-Web Forming of Aarhus, Denmark, M&J Fibretech A/S of Horsens, Denmark, Rando Machine Corporation, Macedon, N.Y. which is described in U.S. Pat. No. 3,972,092, which is incorporated herein in its entirety by reference thereto. Margasa Textile Machinery of Cerdanyola del Valles, Spain, and DOA International of Wels, Austria. While these many forming machines differ in how the fiber is opened and air-conveyed to the forming wire, they all are capable of producing the webs of the presently disclosed subject matter. The Dan-Web forming heads include rotating or agitated perforated drums, which serve to maintain fiber separation until the fibers are pulled by vacuum onto a foraminous forming conveyor or forming wire. In the M&J machine, the forming head is basically a rotary agitator above a screen. The rotary agitator may comprise a series or cluster of rotating propellers or fan blades. Other fibers, such as a synthetic thermoplastic fiber, are opened, weighed, and mixed in a fiber dosing system such as a textile feeder supplied by Laroche S. A. of Cours-La Ville, France. From the textile feeder, the fibers are air conveyed to the forming heads of the airlaid machine where they are further mixed with the comminuted cellulose pulp fibers from the hammer mills and deposited on the continuously moving forming wire. Where defined layers are desired, separate forming heads may be used for each type of fiber.

In certain embodiments, a binder can be sprayed, wiped, or otherwise applied to a portion of at least one outer surface of the nonwoven material. The binder can be directly applied to the nonwoven material. Alternatively, the binder can be combined with one or more other components before being applied to the nonwoven material.

The airlaid web is transferred from the forming wire to a calendar or other densification stage to densify the web, if necessary, to increase its strength and control web thickness. In one embodiment, the fibers of the web are then bonded by passage through an oven set to a temperature high enough to fuse the included thermoplastic or other binder materials.

In a further embodiment, secondary binding from the drying or curing of a latex spray or foam application occurs in the same oven. The oven can be a conventional through-air oven, be operated as a convection oven, or may achieve the necessary heating by infrared or even microwave irradiation. In particular embodiments, the airlaid web can be treated with additional additives before or after heat curing.

In certain embodiments, after applying a binder (e.g., a binder that is part of a carrier composition), the nonwoven material is treated with a solution comprising a sanitizing agent. For example, the nonwoven material can be treated with the solution during or after conversion. In certain embodiments, the solution is applied by spraying the solution onto the nonwoven material. The spraying can be performed after converting the nonwoven material. However, a person of ordinary skill in the art will appreciate that the methods of applying the solution can vary depending on several factors, including the composition of the nonwoven material and the method of conversion.

### 6. EXAMPLES

The presently disclosed subject matter will be better understood by reference to the following Examples. The following examples are merely illustrative of the presently disclosed subject matter and they should not be considered as limiting the scope of the subject matter in any way.

### Method of Forming Laboratory-Scale Handsheet

Several of the examples described herein used a laboratory airlaid handsheet apparatus that lays down a 35.56 cm×35.56 cm (14 in×14 in) pad. This size pad can be called an airlaid handsheet and can be suitable for laboratory scale experiments, prior to use with an airlaid machine to produce a continuous web. The airlaid handsheet apparatus has a supported forming wire that can be removed and repositioned by rotating the forming wire 90 degrees. Vacuum is applied to bottom of the forming wire, while materials to be airlaid are air conveyed to the top of the forming wire. To make an airlaid handsheet on the airlaid handsheet former, a carrier tissue is placed on the forming wire to aid in the collection of material on the forming wire. One example of a tissue carrier often used is an 18 gsm, 1 ply, 1.6 cubic meters/min (55.3 cubic feet/minute) tissue manufactured by Cellu Tissue Holdings, Inc., of Alpharetta, Georgia. Weighed amounts of various fibers are added to a mixing chamber where jets of air fluidize and mix the fibers. The fluidized cloud of fibers is pulled down onto the forming wire by the vacuum source.

Prior to feeding to the handsheet apparatus, chosen comminution sheet fibers are mechanically defibrated, or comminuted into a low density, individualized, fibrous form known as fluff. Mechanical defibration may be performed by a variety of methods which are known in the art. Typically a hammer mill is employed. One example of a hammer mill, a Type KVARN Kamas Mill from Kamas Industri AB, Sweden with a 51 mm (2 in) slot, is particularly useful for laboratory scale production of fluff. Additionally, a three stage fluffer is another example of a laboratory comminution device. For larger samples, a hammer mill such as a Type H-12-KD Kamas Mill from Kamas Industri AB, Sweden with a 101.6 mm (4 in) slot is employed. The laboratory scale airlaid handsheet apparatus can be operated step-wise to simulate the commercial multiple-forming-head airlaid process to airlay the fiber mixtures into the 35.56 cm (14 in) square handsheets.

For low basis weight materials, the airlaid handsheet apparatus is used to build an airlaid handsheet in up to twelve (12) steps to produce as many layers. Forming the airlaid handsheet in this many steps helps to ensure that the batch-type forming head of the laboratory airlaid handsheet apparatus better simulates the degree of homogeneity which is obtained in a multiple forming head, continuous airlaid manufacturing machine. After each portion of the total weight of fibers is laid down, the forming wire is turned 90 degrees in the apparatus. This procedure helps to minimize air turbulence artifacts and delivers a more uniform handsheet. In this step-wise fashion the entire airlaid handsheet is formed. Finally, a second carrier tissue is placed on the top of the handsheet.

### Example 1

### Nonwoven Materials with Antimicrobial Properties

This Example describes methods of preparing nonwoven materials that can be used as a support for a cationic compound, such as a quaternary ammonium salt. This Example compares the antimicrobial properties of nonwoven materials made with and without modified cellulose fibers.

Four samples were prepared. Sample 1A contained 15 wt-% Trevira-257 bicomponent fibers and 85 wt-% GP-4725 pulp (unmodified cellulose fibers). Sample 1B contained 15 wt-% Trevira-257 bicomponent fibers and 85 wt-% FFLE+pulp (modified cellulose fibers). The compositions of these samples are summarized in Table 1, and were the same except that Sample 1A contained unmodified cellulose fibers and Sample 1B contained modified cellulose fibers.

TABLE 1
Composition of Samples 1A and 1B

| | gsm |
|---|---|
| Sample 1A | |
| GI 4725 | 68 |
| Trevira-257 | 12 |
| TOTAL | 80 |
| Sample 1B | |
| FFLE+ | 68 |
| Trevira-257 | 12 |
| TOTAL | 80 |

Similarly, Sample 1C contained 20 wt-% Trevira-257 bicomponent fibers and 80 wt-% GP-4725 pulp. Sample 1D contained 20 wt-% Trevira-257 bicomponent fibers and 80 wt-% FFLE+pulp. The compositions of these samples are summarized in Table 2, and were the same except that Sample 1C contained unmodified cellulose fibers and Sample 1D contained modified cellulose fibers.

TABLE 2
Composition of Samples 1C and 1D

| | gsm |
|---|---|
| Sample 1C | |
| GI-4725 | 64 |
| Trevira-257 | 16 |
| TOTAL | 80 |
| Sample 1D | |
| FFLE+ | 64 |
| Trevira-257 | 16 |
| TOTAL | 80 |

The samples were airlaid as hand sheets using a pad blower. Each hand sheet was placed on three cardboards, roller pressed 4 times, and cured for 4 minutes at 144° C. Each hand sheet was cut to a 12×12 inch square and weighed. Each hand sheet was sprayed with water until moist to approximate an aqueous environment, then sealed in separate plastic bags. The bags were dated and then placed in an oven and heated to roughly 35° C. for ten minutes. The bags were then stored in a dark, sealed cabinet.

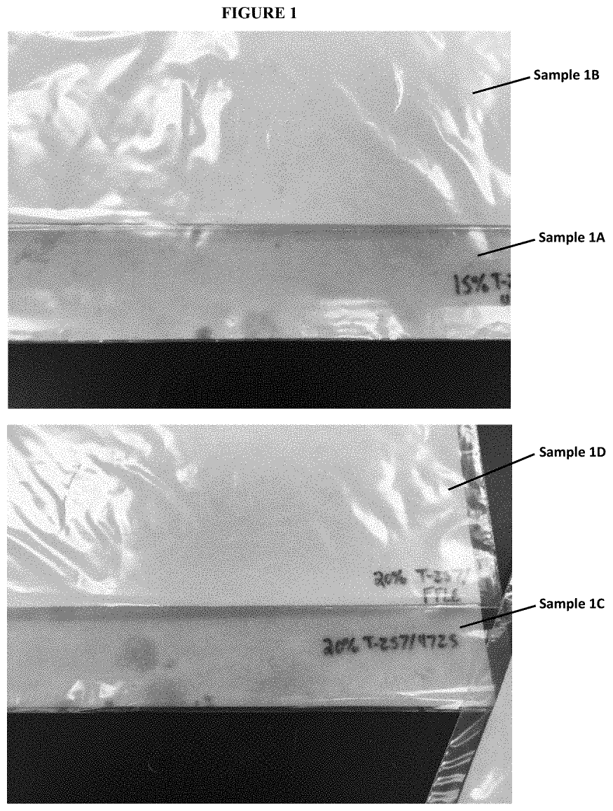

The bags were inspected for mold growth at regular intervals. Signs of mold were observed on the GP-4725 containing hand sheets (Samples 1A and 1C) after 8 days, with no signs of mold on the FFLE+ containing hand sheets (Samples 1B and 1D). Photographs were taken of the four samples after 18 days, and show that mold was observed only in Samples 1A and 1C (see FIG. 1).

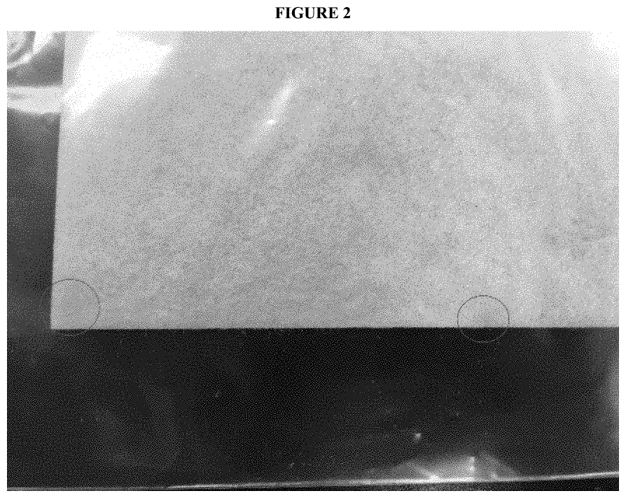

After 35 days, mold continued to grow on the GP-4725 containing hand sheets (Samples 1A and 1C), but no mold was observed on the FFLE+containing hand sheets (Samples 1B and 1D). The first signs of mold on the FFLE+containing hand sheets occurred on Sample 1D after 53 days, as shown in FIG. 2. The experiment was terminated after 77 days, during which time no mold appeared on the Sample 1B, and no additional mold was observed on the Sample 1D. As such, the hand sheets containing modified cellulose fibers were found to have improved antimicrobial properties as compared to the hand sheets with unmodified cellulose fibers when stored in an aqueous environment.

### Example 2

### Nonwoven Materials with Antimicrobial Properties

This Example compares the antimicrobial properties of nonwoven materials made with and without modified cellulose fibers.

Four samples were prepared. Sample 2A contained 10 wt-% Trevira-257 bicomponent fibers and 90 wt-% GP-4725 pulp (unmodified cellulose fibers). Sample 2B contained 10 wt-% Trevira-257 bicomponent fibers and 90 wt-% FFLE+pulp (modified cellulose fibers). The compositions of these samples are summarized in Table 3, and were the same except that Sample 2A contained unmodified cellulose fibers and Sample 2B contained modified cellulose fibers.

TABLE 3
Composition of Samples 2A and 2B

| | gsm |
|---|---|
| Sample 2A | |
| GI-4725 | 72 |
| Trevira-257 | 8 |
| TOTAL | 80 |
| Sample 2B | |
| FFLE+ | 72 |
| Trevira-257 | 8 |
| TOTAL | 80 |

Similarly, Sample 2C contained 30 wt-% Trevira-257 bicomponent fibers and 70 wt-% GP-4725 pulp. Sample 2D contained 30 wt-% Trevira-257 bicomponent fibers and 70 wt-% FFLE+pulp. The compositions of these samples are summarized in Table 4, and were the same except that Sample 2C contained unmodified cellulose fibers and Sample 2D contained modified cellulose fibers.

TABLE 4
Composition of Samples 2C and 2D

| | gsm |
|---|---|
| Samples 2C | |
| GI-4725 | 56 |
| Trevira-257 | 24 |
| TOTAL | 80 |
| Samples 2D | |
| FFLE+ | 56 |
| Trevira-257 | 24 |
| TOTAL | 80 |

The samples were inoculated with worst case mold. Samples 2A and 2C, which contained unmodified cellulose fibers, grew mold within 5 days that then spread to the majority of the sheet within 14 days. Sample 2B, which contained 10 wt-% modified cellulose fibers, began showing signs of mold growth after 21 days of testing, while Sample 2D, which contained 30 wt-% modified cellulose fibers showed no signs of mold growth after 21 days.

### Example 3

### Quat Depletion of Nonwoven Materials

This Example compares the quat depletion of nonwoven materials made with and without modified cellulose fibers and provides nonwoven materials that can be used in combination with a cationic sanitizing agent.

Four samples of hand sheets were prepared as described in Example 1 (Samples 3A-3D, having the same compositions as Samples 1A-1D, respectively). Samples 3A-3D were prepped for quat depletion analysis by soaking each hand sheet overnight in a gallon of a sanitizing lotion comprising a quaternary ammonium compound (“quat”). The samples were then wrung out into small, individual jars. Each jar of lotion was tested against the original sanitizing lotion using an autotitration method. This analysis allowed for the evaluation of the amount of active quat present in each jar of lotion as compared to the original amount of active quat. The results are presented in Table 5.

TABLE 5
Quat Depletion Based on Titration of Samples 3A-3D

| | Titration |
|---|---|
| | Results |
| Sample | (mg/L) |
| Control (sanitizing lotion) | 1095 |
| Sample 3A (15 wt-% T-257/85 wt-% GI-4725) | 1180 |
| Sample 3B (15 wt-% T-257/85 wt-% FFLE+) | 1131 |
| Sample 3C (20 wt-% T-257/80 wt-% GI-4725) | 1200 |
| Sample 3D (20 wt-% T-257/80 wt-% FFLE+) | 1200 |

As shown in Table 5, each of the samples contained more active quat than the Control, presumably because some liquid solution was absorbed into the nonwoven material while the active quat remained in the solution that was not absorbed.

Two additional samples were prepared (Sample 3E and Sample 3F. Sample 3E was prepared with 80 gsm of 100 wt-% GP-4725 pulp. Sample 3F was prepared with 80 gsm of 100 wt-% FFLE+pulp. Samples 3E and 3F were prepared as hand sheets by soaking 7.43 grams of the respective pulp in water for 4 hours and using a CPF Hand Sheet Former to form each hand sheet. Each hand sheet was then steamrolled at 250 ° C. and cut. Samples 3E and 3F were prepared for quat depletion analysis as described in connection with Samples 3A-3D, but quat depletion was tested via LC-MS to determine a value for total quat (both active and inactive) present in the recovered lotion. These results are presented in Table 6.

TABLE 6
Quat Depletion Based on LC-MS of Samples 3E-3F

| | LC-MS Results |
|---|---|
| Sample | (mg/L) |
| Control (sanitizing lotion) | 1046 |
| Sample 3E (10 wt-% T-257/90 wt-% FFLE+) | 1075 |
| Sample 3F (30 wt-% T-257/70 wt-% FFLE+) | 1200 |

As shown in Table 6, each of the samples contained more active quat than the Control, presumably because some liquid solution was absorbed into the nonwoven material while the quat remained in the solution that was not absorbed.

### Example 4

### Aluminum Leaching of Nonwoven Materials in a Lotion

This Example compares aluminum leaching from nonwoven materials made with modified cellulose fibers in accordance with the presently disclosed subject matter to aluminum leaching from other commercially-available materials made with modified cellulose fibers.

Four 320 gsm airlaid handsheets (Samples 4A-4D) were formed and pressed on the airlaid handsheet former. After the air laying step, the airlaid handsheet was pressed in a roller press. The sheet was placed between two 700 gsm comminution pulp sheets and run through the press 6 times, turning the sandwich 90 degrees between each turn. The comminution pulp sheets were then removed along with the two tissue sheets so the sample could be placed on a wire support in a through air oven for curing at 150° C. for 5 minutes. The sample was then removed, inverted upside down, and placed back on the wire support for an additional 5-minute cure at 150° C. The compositions of each of Samples 4A-4D are provided in Table 7, below.

TABLE 7
Composition of Airlaid Handsheets (Samples 4A-4D)

| | | | | Bicomponent |
|---|---|---|---|---|
| | | Cellulose | | Fiber |
| | | Amount | Bicomponent | Amount |
| Sample | Cellulose Fluff Type | (wt-%) | Fiber Type | (wt-%) |
| 4A | FFLE+ | 80 | Trevira 255 | 20 |
| 4B | FFLE+ | 80 | Trevira 255 | 20 |
| 4C | Competitive modified | 80 | Trevira 255 | 20 |
| | pulp | | | |
| 4D | Competitive modified | 80 | Trevira 255 | 20 |
| | pulp | | | |

A sanitizing lotion was diluted from its concentrated form to 1.333% solids (weight/weight). This was applied at a ratio of 80 parts liquid to 20 parts airlaid substrate. To do so, the airlaid handsheet was weighed and the volume of lotion to be added was calculated. One-half of that volume was sprayed to each side of Samples 4A and 4C with a Preval® Sprayer. The same procedure was followed, but with water instead of lotion, for Samples 4B and 4D. After spraying, each sample was enclosed in a sealed plastic bag for 24 hours.

Each sample was pressed to express the lotion or water by running through a mini press roll unit at approximately 0.078 m/s (4.7 m/min). Roll pressure was set to 345 kPa (50 psi). This press comprised a Dayton model 4Z382b motor turning a rubber/metal roll pneumatic press. The liquid collected from each sheet was captured separately in a metal pan lined with a plastic bag. The liquid was then transferred to a plastic bottle for analysis. After collection of each liquid sample, the press was rinsed with water and dried prior to collection of the following liquid samples. The samples were then tested along with several controls via inductively coupled plasma optical emission spectrometry for their aluminum contents. The controls were the dilute sanitizing lotion (Sample 4E), water (Sample 4F), and FFLE+ fluffs (Sample 4G). The aluminum leaching results are provided in Table 8, below.

TABLE 8
Aluminum Leaching of Samples 4A-4G

| Sample | Sample Composition | Aluminum μg/g 396.152 nm |
|---|---|---|
| 4A | FFLE+/Trevira 255 in lotion | 49.7 |
| 4B | FFLE+/Trevira 255 in water | 20.0 |
| 4C | Competitive Modified | 201 |
| | Pulp/Trevira 255 in lotion | |
| 4D | Competitive Modified | 207 |
| | Pulp/Trevira 255 in water | |
| 4E | 1.333% sanitizing lotion control | Below detection limit |
| 4F | Water control | Below detection limit |
| 4G | FFLE+ fluff control | 6411 |

As illustrated in Table 8, nonwoven materials made according to the present disclosure (Samples 4A and 4B) leach significantly less aluminum to the liquid environment, as compared to competitive modified pulps (Samples 4C and 4D). The measured aluminum was not contributed by contaminants in the lotion or water. The total amount of aluminum in FFLE+ fibers includes all aluminum present on the sample, both leachable and non-leachable, but only the leachable component was extractable in lotion or water, as demonstrated by Samples 4A and 4B.

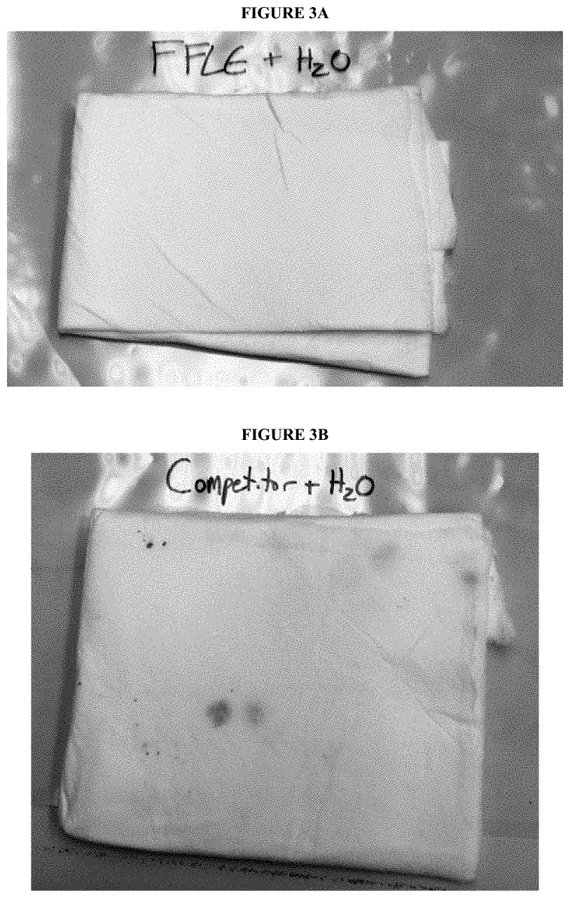

Additionally, after being pressed to extract the liquid samples, Samples 4B and 4D were placed back into the plastic bags and sealed. The samples were stored at room temperature for 36 days. After 36 days, the samples were removed and photographed (see FIGS. 3A-3B). Mold was observed on Sample 4D (see FIG. 3B). However, no mold was observed on Sample 4B (see FIG. 3A). Thus, the presently disclosed nonwoven materials have improved mold resistance as compared to those made with competitive modified pulps. These data show that the nonwoven materials of the present disclosure are suitable for immersion and storage in a liquid environment, and are therefore suitable for use as a wet wipe material.

### Example 5

### Quat Depletion of Nonwoven Materials Containing Modified Cellulose Fibers

This Example compares the quat depletion of nonwoven materials with and without modified cellulose fibers. Samples 10A-10B were prepared as handsheets such that Sample 10A contained non-modified cellulose fibers and Sample 10B contained modified cellulose fibers.

For this Example, 80 gsm airlaid handsheets were formed and pressed on the airlaid handsheet former with the compositions shown in Table 9, below. After the air laying step, the airlaid handsheets were pressed in a roller press. The sheets were placed between two 700 gsm comminution pulp sheets and run through the press 4 times, turning the sandwich 90 degrees between each turn. The comminution pulp sheets were then removed along with one of the tissue sheets. The first side of the sheet without tissue was sprayed with 50% of the binder target, placed on a vacuum box for 5 seconds, and then put on a wire support in a through air oven for curing at 160° C. for 5 minutes. The sample was then removed, inverted upside down, the second tissue removed, the last half of the binder applied by Preval® Sprayer, placed on a vacuum box for 5 seconds, and then placed back on the wire support for an additional 5-minute cure at 160°.

TABLE 9
Compositions of Samples 5A-5B

| | | Cellulose | | Binder |
|---|---|---|---|---|
| Sample | Cellulose Type | Amount (%) | Binder Type | Amount (%) |
| 5A | GI-4725 | 86 | Celanese Dur- | 14 |
| | | | 0-Set 25-010A | |
| 5B | FFLE+ | 86 | Celanese Dur- | 14 |
| | | | O-Set 25-010A | |

A disinfecting lotion was diluted from its concentrated version to 1.333% solids (weight/weight). This diluted lotion was applied at a ratio of 80 parts liquid to 20 parts airlaid substrate. This was done by weighing the airlaid handsheet, calculating the volume of lotion to be added, and spraying one half of that volume to each side of the airlaid handsheets with a Preval® Sprayer. After spraying each sheet was enclosed in a sealed plastic bag for 24 hours.

The airlaid handsheets were pressed to express the lotion or water by running through a mini press roll unit at approximately 0.078 m/s (4.7 m/min). Roll pressure was set to 345 kPa (50 psi). This press is comprised of a Dayton model 4Z382b motor turning a rubber/metal roll pneumatic press. The liquid collected from each sheet was captured separately in a metal pan lined with a plastic bag. The liquid was combined for like conditions (all expressed liquid for the sheets from 5A were combined but kept separate from the other conditions). The liquid was then transferred to a plastic bottle for analysis. After collection of each sample, the press was rinsed with water and dried prior to collection of the following samples. The samples were then tested along with a control with an autotitration method. This analysis allowed for the evaluation of the active quat present in each sample compared to the original amount of active quat. The results are presented in Table 10.

TABLE 10
Quat Depletion Based on Titration of Samples 5A-5B

| | Titration Results |
|---|---|
| Sample | (mg/L) |
| Control (dilute lotion) | 2854 |
| 5A | 1145 |
| 5B | 1391 |

As illustrated in Table 10, nonwoven materials made according to the present disclosure and containing modified cellulose fibers (Sample 5B) deplete less of the active quat than nonwoven materials made with non-modified cellulose (Sample 5A).

### Example 6

### Sample Low Basis Weight Nonwoven Material

This Example describes a nonwoven material having a low basis weight and containing modified cellulose fibers in accordance with the present disclosure.

A sample of a 60 gsm thermal-bonded airlaid (TBAL) material can be made using lab-scale stationary equipment. This nonwoven material can be used as a support for a cationic compound, such as quaternary ammonium salt contained in a sanitizing solution. For example, the sample can contain 75 wt-% modified cellulose fibers (FFLE+. Georgia-Pacific) and 15 wt-% Trevira-257 bicomponent fibers.

The basic physical properties of the sample can be as listed in Table 11, below.

TABLE 11
Properties of Low Basis Weight Nonwoven Material

| Parameter | |
|---|---|
| Caliper | 1.2 mm |
| MDD Tensile Strength | 520 g/inch |

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

Various patents and patent applications are cited herein, the contents of which are hereby incorporated by reference herein in their entireties.

1. A nonwoven material, comprising:
from about 10 wt-% to about 90 wt-% of modified cellulose fibers;
from about 10 wt-% to about 90 wt-% of synthetic fibers; and
a solution comprising a sanitizing agent.

2. The nonwoven material of claim 1, wherein the modified cellulose fibers comprise aluminum.

3. The nonwoven material of claim 2, wherein less than about 200 ppm of aluminum is leached to the solution.

4. The nonwoven material of claim 2, wherein the modified cellulose fibers further comprise a weak acid.

5. The nonwoven material of claim 1, wherein the synthetic fibers are bicomponent fibers.

6. A nonwoven material, comprising:
modified cellulose fibers, wherein the modified cellulose fibers are treated with a polyvalent metal salt; and
a solution comprising a sanitizing agent.

7. The nonwoven material of claim 6, wherein the modified cellulose fibers are treated with an aluminum salt.

8. The nonwoven material of claim 7, wherein less than about 200 ppm of aluminum is leached to the solution.

9. (canceled)

10. (canceled)

11. The nonwoven material of claim 6, wherein the modified cellulose fibers further comprise a weak acid.

12. The nonwoven material of claim 1, wherein the nonwoven material has a basis weight of from about 30 gsm to about 200 gsm.

13. The nonwoven material of claim 1, wherein the nonwoven material has a caliper of from about 0.3 mm to about 2.0 mm.

14. The nonwoven material of claim 1, wherein the nonwoven material comprises two or more layers.

15. The nonwoven material of claim 1, wherein the nonwoven material has a CDW tensile strength of greater than about 200 g/inch.

16. (canceled)

17. The nonwoven material of claim 1, wherein the nonwoven material has a MDD tensile strength of greater than about 300 g/inch.

18. (canceled)

19. The nonwoven material of claim 1, wherein the solution comprises from about 0.05 wt-% to about 5 wt-% of the sanitizing agent.

20. The nonwoven material of claim 1, wherein the sanitizing agent is a quaternary ammonium compound.

21. The nonwoven material of claim 20, wherein the quaternary compound is selected from the group consisting of dioctyldecyl dimethyl ammonium chloride, octyl decyl dimethyl ammonium chloride, alkyl dimethyl benzyl ammonium chloride, and combinations thereof.

22. The nonwoven material of claim 20, wherein the nonwoven material has a quat depletion of at least about 40% as compared to an initial amount of the quaternary ammonium compound in the solution before the solution is applied to the nonwoven material.

23. The nonwoven material of claim 1, further comprising an antimicrobial agent.

24. The nonwoven material of claim 1, wherein the nonwoven material is mold resistant when stored in an aqueous environment for at least about 35 days.

25. (canceled)

26. (canceled)
